(19) United States
(12) Patent Application Publication
(10) Pub. No.: US 2012/0152845 A1
(43) Pub. Date: Jun. 21, 2012

(54) POROUS SILICA-METAL ORGANIC COMPOSITE ADSORBENTS AND METHODS OF MAKING AND USING THE SAME

(75) Inventors: M. Douglas LeVan, Brentwood, TN (US); Amanda M.B. Furtado, Clarksville, TN (US); Jian Liu, Richland, WA (US); Yu Wang, Nashville, TN (US)

(73) Assignee: VANDERBILT UNIVERSITY, Nashville, TN (US)

(21) Appl. No.: 13/118,047

(22) Filed: May 27, 2011

Related U.S. Application Data
(60) Provisional application No. 61/348,805, filed on May 27, 2010.

(51) Int. Cl. B01J 20/22; A62D 101/02; C02F 1/42; A62D 3/00; B01D 15/04; B01D 53/04; B01J 20/32; A62D 101/00

(52) U.S. Cl. 210/660; 502/401; 502/62; 588/401; 588/400; 588/300; 95/90

(57) ABSTRACT

An adsorbent material comprising a metal organic phase and a porous silica phase is provided. The adsorbent material can be a synthesized from at least one porous silica material, one or more metal ions, and at least one organic linker comprising one or more multidentate functional groups capable of forming coordinate bonds with the metal ions. The porous silica can be an ordered mesoporous silica material. Methods of making the adsorbent material and methods of removing molecules from a fluid using the adsorbent material are also provided.

### CROSS REFERENCE TO RELATED APPLICATIONS

This application claims the benefit of Provisional U.S. Patent Application Ser. No. 61/348,805, filed on May 27, 2010, the entirety of which is incorporated by reference herein.

### STATEMENT REGARDING FEDERALLY SPONSORED RESEARCH

This invention was made with government support under RDECOM # W911SR-08-C-0028, awarded by United States Army Edgewood Chemical and Biological Center. The government has certain rights in the invention.

### BACKGROUND

1. Field

The present invention relates to adsorbent materials in general and, in particular, to a composite adsorbent material comprising a porous silica phase and a metal organic phase and to methods of making and using the adsorbent material.

2. Background of the Technology

The ability for gas purification is an integral technology in today's society. With the advent of air quality threats ranging from pollution to terrorism, the ability to remove light gases such as industrial chemicals and chemical warfare agents reliably from air or other gases is a necessity. Similar concerns pertain to the purification of liquids.

According to the technical market research firm Business Communications Company, the estimated global market for microporous adsorbent materials in 2012 is $2.12 billion (http://www.physorg.com/news5208.html). Some current commercial adsorbents such as the metal-impregnated activated carbon produced by Calgon Carbon Corporation provide protection against air contaminants. Although they do not break down their annual earnings report by specific products, Calgon Carbon reported $358 million in income for the 2009 year for their Activated Carbon and Service division (http://www.calgoncarbon.com). Metal impregnated activated carbons currently hold a large share of the market to provide protection against toxic light gas threats. However, the adsorbent industry is intent on innovating and producing more uniform and engineered materials tailored for specific purposes. This includes the development of novel adsorbents for liquid-phase applications, such as the desulfurization of diesel fuels.

Metal-organic framework (MOF) adsorbent materials are well known for their large surface areas and open structures which can have high capacities for light gases. The MOF materials consist of metal ions coordinated to organic linkers that form porous materials with extremely high surface areas and low densities (Rosi, et al., Science, 300 (2003) 1127). The surface areas and pore sizes of these materials vary based on the size and type of the organic linkers, which are coordinated to metal oxide clusters to provide reactive sites that enhance the chemisorptive ability of the materials (Britt, et al., PNAS, 33 (2008) Vol. 105, 11623). Variations in the type of metal oxide clusters allow these adsorbent materials to be designed for removal of targeted gases. Under dry conditions, MOFs generally have a high capacity for light gas adsorption. One major hurdle to wide-spread utilization of MOFs is their poor hydrothermal stabilities. The structure and porosity of most MOFs collapse upon exposure to water and high temperatures, thereby reducing their effectiveness at air purification. Despite their relatively recent discovery, BASF has already commercialized five metal organic materials, selling them for around $5 per gram by Aldrich (http://pubs.acs.org/cen/coverstory/86/8634cover.html).

Ordered mesoporous silica materials (OMS) are a family of siliceous materials that are popular adsorbents due to their large surface areas and ordered porous structures. OMSs are formed via a liquid crystal templating mechanism using ionic surfactants as structure directing agents. The mesoporous materials are formed by condensing silica onto the surfactant liquid crystals and then removing the surfactant from the final product (F. Hoffmann, et al., Angew. Chem. Int. Ed., 45 (2006) 3216). The versatility of OMS materials have resulted in commercial production of some OMSs. In 2008, Taiyo Kagaku Company Ltd. opened a mesoporous silica production plant in Japan to make these materials commercially available. These silica materials tend to have high adsorption capacity for some basic gases, such as ammonia, and extensive modifications to OMS materials have been performed to enhance their adsorptive ability for other light gases. OMS materials are often used as structure directing agents to form carbonaceous materials with smaller pore sizes. They also can be used as the base material for composite materials (T. G. Glover, K. I. Dunne, R. J. Davis, M. D. LeVan., Microporous Mesoporous Mater., 111 (2008) 1). OMS materials have been found to be extremely stable at high temperature and relative humidities (S. Shen, et al., Langmuir, 18 (2002) 4720).

Composite adsorbent materials comprising metal organics and carbonaceous materials are known. In 2009, Bandosz, et al., reported a composite material made of MOF-5 and graphite oxide. Their composite material showed slight improvements in ammonia capacity in a dry environment when compared to the mixture of the two components. However, the materials were found to be unstable when tested under higher relative humidity (Petit and Bandosz, J. Mater. Chem. 19 (2009) 6521). Two additional papers reference MOF-carbonaceous composite materials. The first, published in 2009, details the synthesis of a MOF-carbon nanotube composite. This composite was found to have higher surface area, enhanced thermal stability, and higher hydrogen storage capacity when compared to the base MOF material (Yang, et al., Chem. Mater. 21 (2009) 1893). In 2010, a MOF was used as a template for a high surface area furfuryl alcohol-based carbonaceous material. Following synthesis of the composite, the MOF structure was removed and the carbonaceous material was found to have ultra-high surface area, on the order of 3000 m²/g (Liu, et al., Carbon 48 (2010) 456). In 2009, Hundal, et al., successfully incorporated polyoxometalate anions into a MOF material and produced a thermally stable, microporous adsorbent material (G. Hundal et al., Polyhedron 28 (2009) 2450). Based on N₂ isotherm analysis, the composite material had a lower surface area than the initial MOF material.

There still exists a need for improved adsorbent materials for light gas removal.

### SUMMARY

An adsorbent material is provided which comprises:

a metal organic phase comprising at least one metal ion coordinated to at least one organic linker; and

a porous silica phase.

A method is also provided which comprises:

(a) impregnating at least one metal ion into at least one porous silica material to form a precursor;

(b) mixing at least one organic linker with the precursor to form a reaction mixture, wherein the organic linker comprises one or more multidentate ligands capable of forming coordinate bonds via a complexation reaction with the at least one metal ion;

(c) adding the reaction mixture to a solution comprising at least one solvent that is different from the reaction mixture; and

(d) allowing the metal ions to form coordinate bonds with the multidentate ligands of organic linker to form a metal organic phase.

A method of removing molecules from a fluid containing the molecules is also provided which comprises:

contacting an adsorbent material with the fluid to allow the adsorbent to adsorb the molecules from the fluid;

wherein the adsorbent material comprises:

a metal organic phase comprising at least one metal ion coordinated to at least one organic linker; and

a porous silica phase

These and other features of the present teachings are set forth herein.

### BRIEF DESCRIPTION OF THE DRAWINGS

The skilled artisan will understand that the drawings, described below, are for illustration purposes only. The drawings are not intended to limit the scope of the present teachings in any way.

FIG. 1 shows the chemical formulae of exemplary aromatic linkers wherein “X” represents functional groups including, but not limited to, —OH, —H, —Cl, —Br, —F, —NH₂, —CH₃, —CH₂CH₃ and other carbonaceous functional groups.

FIG. 2 shows an XRD pattern for the MCM-41-Cu_{—}10%_BTC composite wherein XRD patterns for MCM-41 and CuBTC are included for comparison and wherein BTC stands for 1,3,5-benzenetricarboxylic acid.

FIG. 3 shows SEM images for four different samples: (a) MCM-41-Cu_{—}10%_BTC; (b) CuBTC impurity in MCM-41-Cu_{—}10%_BTC; (c) CuBTC; and (d) MCM-41.

### DESCRIPTION OF THE VARIOUS EMBODIMENTS

The present invention is more particularly described in the following examples that are intended as illustrative only since numerous modifications and variations therein will be apparent to those skilled in the art. Various embodiments of the invention are now described in detail. Referring to the drawings, like numbers indicate like parts throughout the views. As used in the description herein and throughout the claims that follow, the meaning of “a,” “an,” and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which has no influence on the scope of the invention. Additionally, some terms used in this specification are more specifically defined below.

The terms used in this specification generally have their ordinary meanings in the art, within the context of the invention, and in the specific context where each term is used.

Certain terms that are used to describe the invention are discussed below, or elsewhere in the specification, to provide additional guidance to the practitioner in describing various embodiments of the invention and how to practice the invention. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and in no way limits the scope and meaning of the invention or of any exemplified term. Likewise, the invention is not limited to various embodiments given in this specification.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

As used herein, if any, the term “scanning electron microscope (SEM)” refers to a type of electron microscope that images the sample surface by scanning it with a high-energy beam of electrons in a raster scan pattern. The electrons interact with the atoms that make up the sample producing signals that contain information about the sample's surface topography, composition and other properties such as electrical conductivity.

As used herein, if any, the term “X-ray diffraction (XRD)” refers to a method of determining the arrangement of atoms within a crystal or solid, in which a beam of X-rays strikes a crystal and diffracts into many specific directions. From the angles and intensities of these diffracted beams, a crystallographer can produce a three-dimensional picture of the density of electrons within the crystal. From this electron density, the mean positions of the atoms in the crystal can be determined, as well as their chemical bonds, their disorder and various other information. In an X-ray diffraction measurement, a crystal or solid sample is mounted on a goniometer and gradually rotated while being bombarded with X-rays, producing a diffraction pattern of regularly spaced spots known as reflections. The two-dimensional images taken at different rotations are converted into a three-dimensional model of the density of electrons within the crystal using the mathematical method of Fourier transforms, combined with chemical data known for the sample.

The present invention, in one aspect, relates to a composite adsorbent material useful for removing contaminant molecules from fluids, including toxic light gases from air. The adsorbent material is a two-phase composite material comprising a metal-organic (MO) phase in and a porous silica phase. The porous silica phase can comprise an ordered mesoporous silica (OMS). It has been shown (see below) that the porous silica phase provides the adsorbent with enhanced stability, including the ability to be conditioned at high temperatures and relative humidities and the MO phase promotes additional physical and chemical adsorption capacity.

The composite adsorbent materials described herein exhibit enhanced hydrothermal stability compared to metal-organic adsorbents. Further, the MO phase provides active sites on the OMS material to allow for chemisorption. This results in composite adsorbent materials that have high capacities for toxic chemical removal and are stable up to high temperatures and under humid conditions.

According to some embodiments, synthesis of the novel OMS-MO materials involves the following. Metal ions, including Mg²⁺, V⁴⁺, V³⁺, V²⁺, Cr³⁺, Mo³⁺, Mn²⁺, Fe²⁺, Fe³⁺, Co³⁺, Co²⁺, Ni²⁺, Ni¹⁺, Cu²⁺, Cu¹⁺, Zn²⁺, Al³⁺, Ga³⁺ and combinations thereof, are impregnated into a porous silica material (e.g., OMS materials, such as SBA-15, MCM-48, MCM-41, fumed silica, and silicalite zeolites) using wet chemistry methods. The metal impregnated silica frameworks are designated here as OMS-M_Y (M=metal, Y=amount of metal). According to some embodiments, the amount of metal can range from 5% to 50%. The metal impregnated silica frameworks are then used as precursors to synthesize the composite adsorbents.

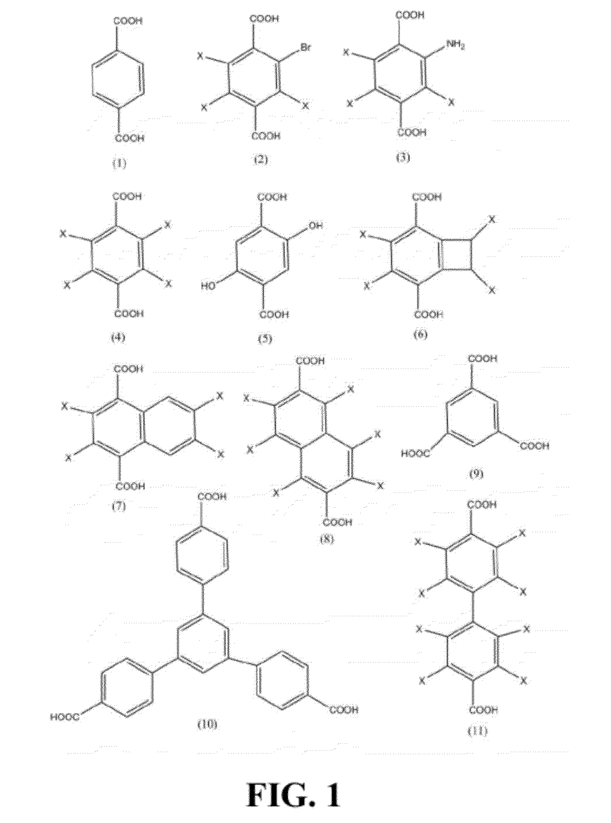

After immobilizing the metal within the silica framework precursor, organic linkers comprising a plurality of multidentate ligands are added to the reaction mixture. The organic linkers may be aromatic linkers comprising one or more benzene rings. Some examples of exemplary aromatic linkers are shown in FIG. 1 wherein X is a chemical moiety. Combinations of the organic linkers may be used. The silica framework precursors and organic linkers can be added to solutions comprising one or more solvents that may include water, methanol, ethanol, dimethylformamide, tetrahydrofuran, diethylformamide, acetone, ethyl acetate, dichloromethane, acetonitrile, dimethyl sulfoxide, n-butanol, isopropanol, n-propanol, and acetic acid. Coordinate bonds are then formed between the metal ions and the multidentate ligands. The coordinate bonds can be formed via solvothermal reactions.

In one aspect, the present invention relates to an adsorbent material comprising a metal organic phase and a porous silica phase. According to some embodiments, the biphasic material is a composite material that is synthesized from a porous silica material, at least metal ion, and at least one organic linker comprising one or more multidentate ligands capable of forming coordinate bonds with the at least one metal ion. According to some embodiments, the organic linker is an aromatic linker.

According to some embodiments, the porous silica material comprises: at least one ordered mesoporous silica material selected from the group consisting of SBA-15, MCM-48 and MCM-41; fumed silica; silicalite zeolites; and combinations thereof.

According to some embodiments, the at least metal ion is selected from the group consisting of Mg²⁺, V⁴⁺, V³⁺, V²⁺, Cr³⁺, Mo³⁺, Mn²⁺, Fe²⁺, Fe³⁺, Co³⁺, Co²⁺, Ni²⁺, Ni¹⁺, Cu²⁺, Cu¹⁺, Zn²⁺, Al³⁺, Ga³⁺ and combinations thereof.

According to some embodiments, the aromatic linker comprises one or more benzene rings. The benzene rings in the aromatic linker may be fused.

According to some embodiments, the multidentate ligand is selected from the group consisting of: CO₂H, CS₂H, NO₂, SO₃H, Si(OH)₃, Ge(OH)₃, Sn(OH)₃, Si(SH)₄, Ge(SH)₄, Sn(SH)₄, PO_{S}H, AsO₃H, AsO₄H, P(SH)₃, As(SH)₃; CH(RSH)₂, C(RSH)₃, CH(RNH₂)₂, C(RNH₂)₃, CH(ROH)₂, C(ROH)₃, CH(RCN)₂, C(RCN)₃, wherein R is an alkyl group having from 1 to 5 carbon atoms, or an aryl group consisting of 1 to 2 phenyl rings; and, CH(SH)₂, C(SH)₃, CH(NH₂)₂, C(NH₂)₃, CH(OH)₂, C(OH)₃, CH(CN)₂, and C(CN)₃. The organic linker can be a ligand comprising multidentate functional groups as disclosed in U.S. Pat. No. 5,648,508, which is incorporated by reference herein in its entirety.

In another aspect, the present invention relates to a method of synthesizing an adsorbent material. According to some embodiments, the method comprises: impregnating at least one metal ion into at least one porous silica material to form a precursor; mixing at least one organic linker with the precursor to form a reaction mixture, wherein the organic linker comprises one or more multidentate ligands capable of forming coordinate bonds via a complexation reaction with the at least one metal ion; adding the reaction mixture to a solution comprising at least one solvent that is different from the reaction mixture; and allowing the metal ions to form coordinate bonds with the multidentate ligands of the organic linker to form a metal organic phase. According to some embodiments, the adsorbent can be formed from the solution containing the reaction mixture via one or more solvothermal reactions.

According to some embodiments, the adsorbent is a biphasic material comprising a metal organic phase and a porous silica phase. According to some embodiments, the porous silica phase comprises a mesoporous silica material.

According to some embodiments, the at least metal ion is selected from the group consisting of Mg²⁺, V⁴⁺, V³⁺, V²⁺, Cr³⁺, Mo³⁺, Mn²⁺, Fe²⁺, Fe³⁺, Co³⁺, Co²⁺, Ni²⁺, Ni¹⁺, Cu²⁺, Cu¹⁺, Zn²⁺, Al³⁺, Ga³⁺ and combinations thereof.

According to some embodiments, the porous silica material comprises: at least one ordered mesoporous silica material selected from the group consisting of SBA-15, MCM-48 and MCM-41; fumed silica; silicalite zeolites; and combinations thereof.

According to some embodiments, the at least one aromatic linker comprises a single or multiple benzene rings with multidentate ligands.

According to some embodiments, the solution containing at least one solvent comprises one of water, methanol, ethanol, dimethylformamide, tetrahydrofuran, diethylformamide, acetone, ethyl acetate, dichloromethane, acetonitrile, dimethyl sulfoxide, n-butanol, isopropanol, n-propanol, and acetic acid.

In yet another aspect, the present invention relates to an adsorbent made from the method as set forth above.

In a further aspect, the present invention relates to a method of removing molecules from a fluid containing the molecules. According to some embodiments, the method comprises: contacting an adsorbent material with the fluid to allow the adsorbent to adsorb the molecules from the fluid; wherein the adsorbent material comprises: a metal organic phase comprising at least one metal ion coordinated to at least one organic linker; and a porous silica phase.

According to some embodiments, the adsorbent material is a composite material that is synthesized from at least one porous silica material, at least metal ion, and at least one organic linker.

The fluid can be in a form of gas, or liquid. According to some embodiments, the molecules are contaminant molecules.

According to some embodiments, the fluid is water and the molecules are contaminant molecules.

According to some embodiments, the fluid is air and the molecules are from toxic light gases mixed with said air. According to some embodiments, the toxic light gases comprise industrial chemicals and/or chemical warfare agents.

### EXPERIMENTAL

The practice of this invention can be further understood by reference to the following examples, which are provided by way of illustration only are not intended to be limiting.

A composite adsorbent was synthesized and evaluated. First, MCM-41 with a 37 angstrom pore size was synthesized based on the procedure outlined in the literature (Glover et al., Microporous Mesoporous Mater., 111, pp. 1-11 (2008)). The reaction gel was formed by mixing a solution of 2.4 g of 29 wt % ammonium hydroxide and 21.2 g of 29 wt % hexadecyltrimethylammonium chloride (CTAC) with a solution of 3.04 g of tetramethylammonium hydroxide pentahydrate (TMAOH, 97%) and 20 g of 10 Wt % solution of tetramethylammonium silicate (TMASi, 99.99%, 15-20 wt % in water) and then adding 4.5 g of Cab-O-Sil M5 fumed silica to the solution. After stirring for 30 min., the reaction gel was placed in a Teflon-lined autoclave and held at 80° C. in an oven for four days. Every 24 h, the autoclave was removed from the oven and titrated to a pH of 10.0 using concentrated sulfuric acid for a total of three titrations. At 24 h after the third titration, the product was filtered and washed with distilled water to remove the remaining surfactant and allowed to dry at room temperature for 48 h. The calcination procedure used to burn the surfactant from the MCM-41 involved heating the as-synthesized MCM-41 in air from room temperature to 540° C. at a rate of 1° C. min⁻¹ and holding the temperature at 540° C. for 10 h.

To produce the composite adsorbent, 0.5 g of MCM-41 and 0.16 g copper nitrate (corresponding to one Cu atom per 9 Si atoms) were stirred in an aqueous solution for 3 h. After stirring, the sample (10 mol % Cu-MCM-41) was dried at 80° C. until dry. The sample was then heated in a tube furnace following the temperature schedule of the MCM-41 calcination procedure.

To incorporate the MOF phase, 0.21 g (1.0 mmol) of benzene 1,2,3-tricarboxylic acid was reacted with 0.1 g of copper impregnated MCM-41 in a 60 ml mixed solution composed of equal parts by volume of water and ethanol. The mixture was placed in a Teflon lined autoclave, and the reaction was held at 120° C. for 12 h. Light green crystals were collected after decanting the mother liquid and filtering the remaining mixture. The as-synthesized composite material was first dried in air and then placed in an oven at 120° C. overnight to obtain the final purple composite material. This same procedure was followed to synthesize a control sample, in which the BTC was impregnated on base MCM-41 without copper impregnation.

The composite adsorbent material thus produced had a porous silica phase comprising an ordered mesoporous silica (MCM-41) and a metal organic phase comprising Cu ions coordinated to the carboxylic acid groups of the aromatic linker 1,3,5-benzenetricarboxylic acid (BTC). This composite adsorbent was designated MCM-41-Cu_{—}10%_BTC.

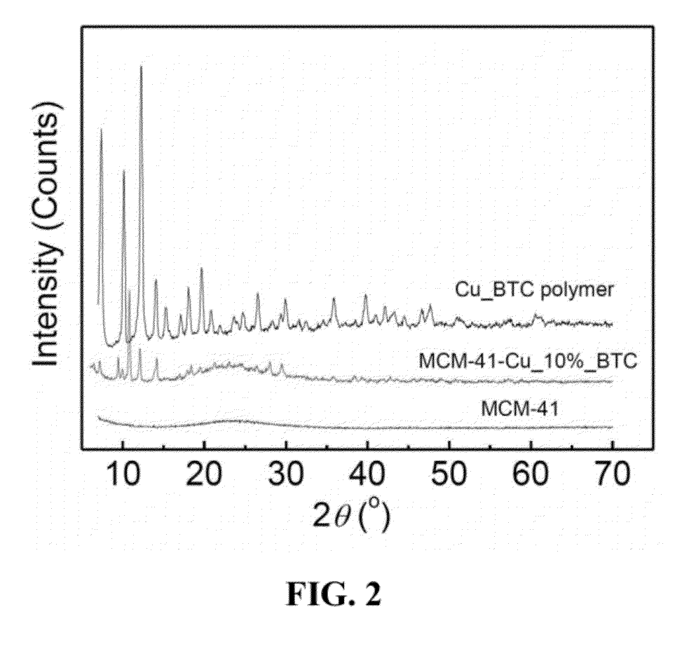

The XRD crystal structure of MCM-41-Cu_{—}10%_BTC composite is shown in FIGS. 2. As can be seen from FIG. 2, the XRD of the MCM-41-Cu_{—}10%_BTC sample includes a broad peak at 23° representative of the amorphous MCM-41 material, and additional peaks representative of a structure formed by the copper and organic linkers (Rowsell, et al., J. Am. Chem. Soc., 128 (2006) 304). It is evident from FIG. 2 that the XRD patterns for MCM-41-Cu_{—}10%_BTC and CuBTC are not the same. Therefore, the structure of the composite adsorbent material is different than that of CuBTC.

Generally, peaks present in the XRD pattern for CuBTC are not present or are much smaller in the MCM41-Cu_{—}10%_BTC sample. The relative strengths of some peaks at the same positions are also different and peak shift is also evident. These results indicate that the Cu-BTC structures in the MCM-41-Cu_{—}10%_BTC sample are different from that of pure crystalline CuBTC. While not wishing to be bound by theory, this may be the result of the Cu²⁺ source being confined close to the surface of the MCM-41.

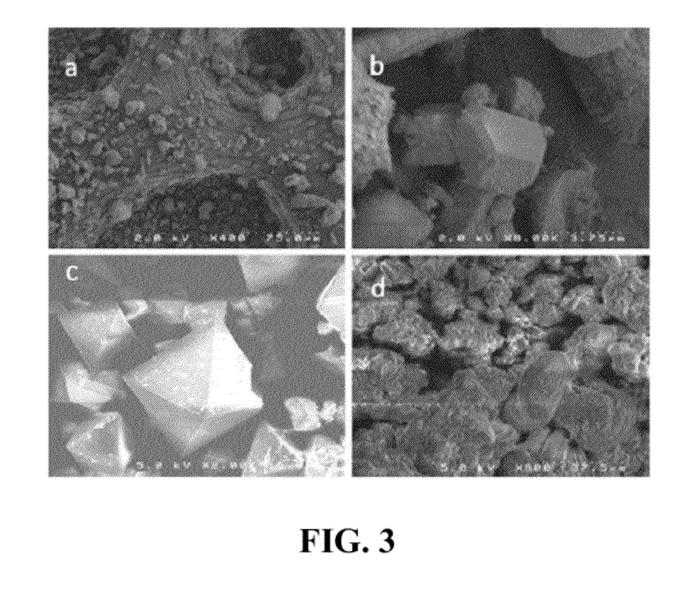

In order to better understand the composite material, SEM was used to study the morphology of the composite sample. The SEM images for the MCM-41-Cu_{—}10%_BTC composite and other samples are shown in FIGS. 3a-d. The MCM-41-Cu_{—}10%_BTC composite contains amorphous structures that are similar in appearance to the MCM-41 SEM images and do not possess large amounts of the octahedral crystals commonly seen for CuBTC. As discussed below for other analytical techniques, the SEM images are consistent with the formation of a composite material that has copper sites dispersed throughout the ordered MCM-41 phase with BTC molecules bound to these copper sites. BTC is not largely associated with a crystalline CuBTC phase formed in bulk; rather, the composite material consists of an ordered MCM-41 phase with BTC bound to copper sites dispersed throughout the silica matrix.

The ammonia capacity of the adsorbent materials was evaluated. In particular, the composite adsorbent material MCM41-Cu_{—}10%_BTC was used to adsorb ammonia from helium. The ammonia capacity of the metal organic adsorbent CuBTC and the ordered mesoporous silica adsorbent MCM-41 was also evaluated. Table 1 below summarizes the dry ammonia capacities for the composite material, CuBTC, and MCM-41. The table includes capacity values for two conditions; the capacities of the initial materials and the capacities after conditioning the samples in 90% relative humidity steam for five hours. All samples are regenerated at over 120° C. and vacuum prior to testing for the ammonia capacity.

TABLE 1
Dry Ammonia Capacities for the Composite Adsorbent Material
MCM41-Cu_10%_BTC, CuBTC and MCM-41

Ammonia Capacity
(mol kg⁻¹)

| Sample | Initial | Conditioned |
|---|---|---|
| CuBTC | 9.6 | 1.5 |
| MCM-41 | 2.0 | 3.4 |
| Cu-MCM-BTC | 5.2 | 4.3 |

As can be seen from the data in Table 1, the ammonia capacity for the composite adsorbent material is higher than the OMS material MCM-41. While not wishing to be bound by theory, it is believed that this enhanced ammonia capacity of the composite adsorbent results from the functionality provided by the metal organic phase. The ammonia capacity of the composite adsorbent was also found to be approximately 30 times higher than that of the common commercial adsorbent BPL activated carbon.

After conditioning the samples in 90% relative humidity hot steam, the CuBTC sample shows an 84% decrease in ammonia capacity, whereas the composite material only lost 17% of its ammonia capacity. These results clearly show that the composite material exhibits higher ammonia capacity relative to the pure OMS material and the composite also exhibits improved hydrothermal stability relative to the pure CuBTC.

Thus, the present invention in one aspect provides a novel biphasic adsorbent material composed of a metal organic phase and a porous silica phase. The composite adsorbent material can be used for the removal of contaminant molecules, including toxic light gases, from fluids including gases and liquids. One application of this material is to provide enhanced adsorption capacity and stability for a broad range of chemicals compared to existing commercial and research grade adsorbent materials.

The foregoing description of the exemplary embodiments of the invention has been presented only for the purposes of illustration and description and is not intended to be exhaustive or to limit the invention to the precise forms disclosed. Many modifications and variations are possible in light of the above teaching.

While several and alternate embodiments of the present invention have been shown, it is to be understood that certain changes can be made as would be known to one skilled in the art without departing from the underlying scope of the invention as is discussed and set forth above and below including claims and drawings. Furthermore, the embodiments described above and claims set forth below are only intended to illustrate the principles of the present invention and are not intended to limit the scope of the invention to the disclosed elements.

While the foregoing specification teaches the principles of the present invention, with examples provided for the purpose of illustration, it will be appreciated by one skilled in the art from reading this disclosure that various changes in form and detail can be made without departing from the true scope of the invention.

What is claimed is:

1. An adsorbent material comprising:
a metal organic phase comprising at least one metal ion coordinated to at least one organic linker; and
a porous silica phase.

2. The adsorbent material of claim 1, wherein the porous silica phase comprises at least one ordered mesoporous silica material.

3. The adsorbent material of claim 1, wherein the porous silica phase comprises: at least one ordered mesoporous silica material selected from the group consisting of SBA-15, MCM-48, and MCM-41; fumed silica; silicalite zeolites; and combinations thereof.

4. The adsorbent material of claim 2, wherein the at least metal ion is selected from the group consisting of Mg²⁺, V⁴⁺, V³⁺, V²⁺, Cr³⁺, Mo³⁺, Mn²⁺, Fe²⁺, Fe³⁺, Co³⁺, Co²⁺, Ni²⁺, Ni¹⁺, Cu²⁺, Cu¹⁺, Zn²⁺, Al³⁺, Ga³⁺ and combinations thereof.

5. The adsorbent of claim 1, wherein the at least one organic linker comprises at least one aromatic linker.

6. A method comprising:
(a) impregnating at least one metal ion into at least one porous silica material to form a precursor;
(b) mixing at least one organic linker with the precursor to form a reaction mixture, wherein the organic linker comprising one or more multidentate ligands capable of forming coordinate bonds via a complexation reaction with the at least one metal ion;
(c) adding the reaction mixture to a solution comprising at least one solvent that is different from the reaction mixture; and
(d) allowing the metal ions to form coordinate bonds with the one or more multidentate ligands of organic linker to form a metal organic phase.

7. The method of claim 6, wherein the porous silica material is an ordered mesoporous silica material.

8. The method of claim 6, wherein the at least metal ion is selected from the group consisting of Mg²⁺, V⁴⁺, V³⁺, V²⁺, Cr³⁺, Mo³⁺, Mn²⁺, Fe²⁺, Fe³⁺, Co³⁺, Co²⁺, Ni²⁺, Ni¹⁺, Cu²⁺, Cu¹⁺, Zn²⁺, Al³⁺, Ga³⁺ and combinations thereof.

9. The method of claim 6, wherein the at least one porous silica material is selected from the group consisting of SBA-15, MCM-48, MCM-41, fumed silica, silicalite zeolites, and combinations thereof.

10. The method of claim 6, wherein the at least one organic linker comprises an aromatic linker.

11. The method of claim 6, wherein the solution comprising at least one solvent comprises a solvent selected from the group consisting of methanol, ethanol, dimethylformamide, tetrahydrofuran, diethylformamide, acetone, ethyl acetate, dichloromethane, acetonitrile, dimethyl sulfoxide, n-butanol, isopropanol, n-propanol, acetic acid and combinations thereof.

12. An adsorbent made by the method of claim 6.

13. A method of removing molecules from a fluid containing the molecules, comprising:
contacting an adsorbent material with the fluid to allow the adsorbent material to adsorb the molecules from the fluid;
wherein the adsorbent material comprises:
a metal organic phase comprising at least one metal ion coordinated to at least one organic linker; and
a porous silica phase.

14. The method of claim 13, wherein the porous silica phase comprises at least one ordered mesoporous silica material.

15. The method of claim 13, wherein the fluid is in a form of gas.

16. The method of claim 13, wherein the fluid is in a form of liquid.

17. The method of claim 13, wherein the fluid is water and the molecules are contaminant molecules.

18. The method of claim 13, wherein the molecules are contaminant molecules.

19. The method of claim 13, wherein the fluid is air and the molecules are from toxic light gases mixed with said air.

20. The method of claim 19, wherein the toxic light gases contain one of industrial chemicals and chemical warfare agents.
